(19) United States
(12) Patent Application Publication
(10) Pub. No.: US 2009/0189683 A1
(43) Pub. Date: Jul. 30, 2009

(54) CIRCUIT FOR GENERATING A REFERENCE VOLTAGE AND METHOD THEREOF

(76) Inventor: Hsien-Hung Wu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/018,804

(22) Filed: Jan. 24, 2008

(51) Int. Cl. G05F 3/16; G05F 3/00

(52) U.S. Cl. 327/543; 327/538

(57) ABSTRACT

A circuit for generating a reference voltage at an output node comprises a first branch, a second branch, and a main current source. The first branch is electrically connected between a first terminal and a second terminal of the circuit, and comprises at least one first semiconductor device. Each first semiconductor device comprises a first node and a second node. The second branch is electrically connected between the first terminal and the second terminal of the circuit, and comprises at least one second semiconductor device and a branch current source. Each second semiconductor device comprises a first node and a second node. The branch current source is serially connected to the second transistor. The main current source is electrically connected to one of the first terminal and the second terminal of the circuit. The output node is in the first branch or the second branch.

### BACKGROUND OF THE INVENTION

1. Field of the Invention

The present invention is related to generating a reference voltage, and more particularly, to a circuit for generating a reference voltage having an adjustable temperature dependency and method thereof.

2. Description of the Prior Art

Various application circuits require a reference voltage to provide a comparing criterion. For example, digital-to-analog circuits and analog-to-digital circuits both require the reference voltage for determining a least significant bit, and regulators require the reference voltage for determining a particular output voltage level, etc. The reference voltage, however, varies with ambient temperature, since the element characteristic of the reference voltage generating circuit varies with ambient temperature. When the comparing criterion is changed, the function or operation of various application circuits may be incorrect. Generating a temperature independent reference voltage is therefore a very important issue for designers.

FIG. 1(a) is a circuit diagram of a conventional temperature independent reference voltage generating circuit. The conventional temperature independent reference voltage generating circuit 100 comprises a proportional to absolute temperature (PTAT) current source 110, a resistor R2 and a BJT Q3. The PTAT current source 110 provides an output current I-PATA that is proportional to absolute temperature. The output current I-PTAT increases with a temperature increase and thus, the voltage difference between the resistor R2 also increases with temperature. Since the base-emitter voltage of BJT Q3 exhibits a property of decreasing with a temperature decrease, a temperature independent voltage reference Vref may be obtained by combining two components having opposite temperature dependency characteristics. The obtained temperature independent reference voltage Vref is also referred as a bandgap voltage because the temperature independent reference voltage Vref approximates the bandgap voltage of silicon (1.25V). Regarding the conventional temperature independent reference voltage generating circuit 100, the resistive value of R2 may vary both with the temperature and the normal process variation, which could seriously affect the exact value of the generated reference voltage. Therefore, after circuit fabrication, the generated voltage reference is measured and some trimming technique on R2 has to be performed, i.e., Zener zapping, metal fuses, and poly fuses.

U.S. Pat. No. 6,441,680 (Leung) discloses a temperature independent reference voltage generating circuit in which the Vgs voltages of a PMOS transistor and an NMOS transistor having similar temperature dependencies are weighted according to a fixed ratio between two resistive elements then mutually compensated to provide a temperature independent voltage reference. Though the voltage reference circuit of Leung’ method does not rely on an exact value of a single resistor and had been proven to be low sensitive in the resistor ratio. Resistive elements, however, can not be totally removed for the sake of lowering design complexity and cost.

One other known example of voltage reference circuit includes those using Zener diode operated at the reverse-breakdown region described in Chapter 4 of Bipolar and MOS Analog Integrated Circuit Desing, by Alan B. Grebene. Most common Zener diodes have a breakdown voltage between 5.5 V and 8.5 V and a positive temperature coefficient (TC) around 1.5 to 5 mV/° C. As shown in FIG. 1(b), by cascading one to three forward-biased p-n junction diodes with a negative TC around −2.2 mV/K, the overall temperature-drift performance can be significantly improved. Also replacing the cascaded p-n junction diodes with a V_{BE} multiplier circuit, shown in FIG. 1(c), is an alternative approach for generating a temperature independent voltage reference based on the Zener diode. However the breakdown voltage of a Zener diode suffers to long-term drift and special process steps must be taken for well controlling this value. Besides, the overall reference voltage is substantially higher than the output voltage of a conventional silicon bandgap reference circuit. This drawback makes Zener-diode-based voltage reference circuit rarely used at applications requiring low supply voltages, for example, less then 3.0V.

U.S. Pat. No. 6,266,221 (Scilla) discloses a process independent thermal protection circuit. The main concept is applying a differentiator circuit to derive a difference voltage signal from the first and second thermal ramp generator. And each thermal ramp generator is composed of one to four series-connected diodes supplied a reference current, which is mirrored by a current mirror respectively. However the offset voltage of a differentiator circuit is unavoidable and should be considered within the design procedures.

Accordingly, what is needed is a circuit to be low design complexity and low cost in the fields of voltage reference and thermal sensor circuit.

### SUMMARY OF THE INVENTION

One objective of the invention is to provide a circuit for generating a reference voltage at an output node. The circuit comprises a first branch, a second branch, and a main current source. The first branch is electrically connected between a first terminal and a second terminal of the circuit, and comprises at least one first semiconductor device. Each first semiconductor device comprises a first node and a second node. The second branch is electrically connected between the first terminal and the second terminal of the circuit, and comprises at least one second semiconductor device and a branch current source. Each second semiconductor device comprises a first node and a second node. The branch current source is serially connected to the second transistor. The main current source is electrically connected to one of the first terminal and the second terminal of the circuit. The output node is in the first branch or the second branch.

Another objective of the invention is to provide a method for generating a reference voltage. The method includes serially connecting each first transistor between a first terminal and a second terminal to generate a first branch, serially connecting each second transistor and a branch current source between the first terminal and the second terminal to generate a second branch, electrically connecting a main current source to one of the first terminal and the second terminal, selecting an output node from the first branch or the second branch, and outputting the reference voltage from the output node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1(a) is a circuit diagram of a conventional temperature independent reference voltage generating circuit.

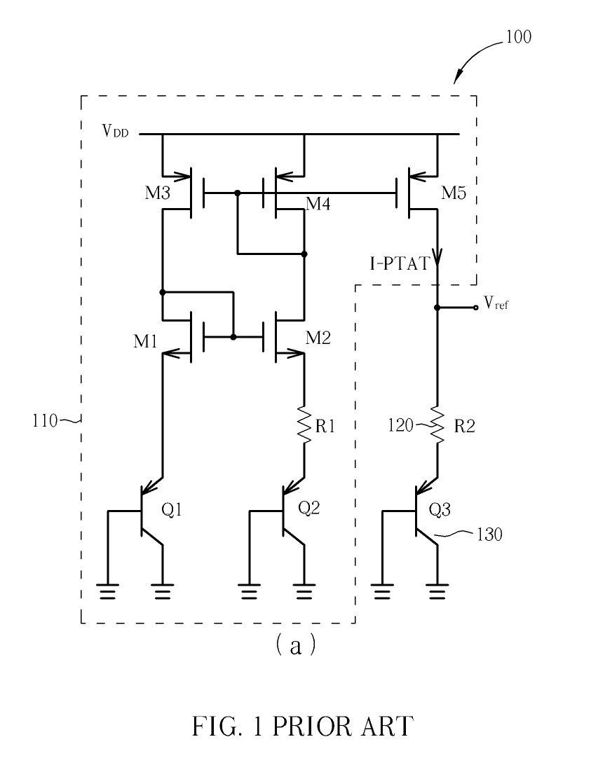

FIG. 1(b) is a circuit diagram of a conventional temperature independent reference voltage generating circuit.

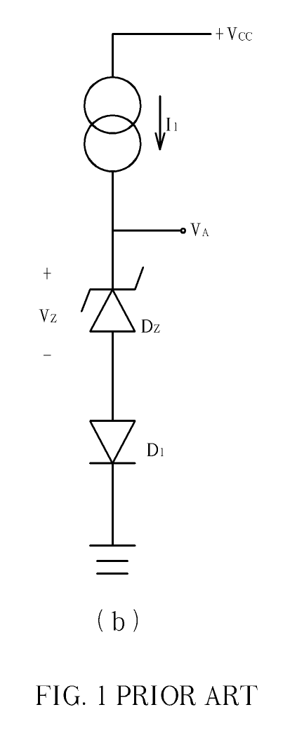

FIG. 1(c) is a circuit diagram of a conventional temperature independent reference voltage generating circuit.

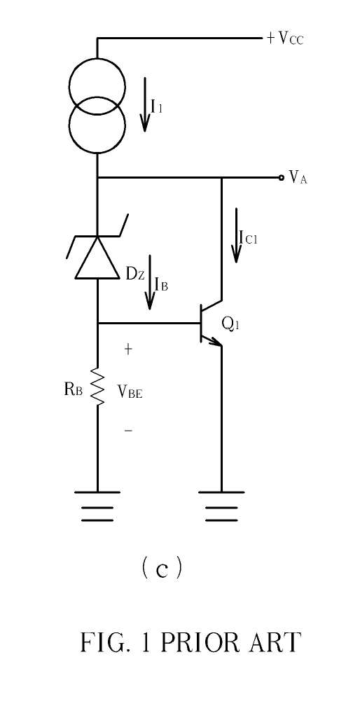

FIG. 2 is a circuit diagram of a reference voltage generating circuit according to an embodiment of the invention.

FIG. 3 is a flowchart showing a method for generating a reference voltage according to an embodiment of the invention.

FIG. 4 is circuit diagram of a thermal indicator according to an embodiment of the invention.

FIG. 5 is a plot illustrating a temperature dependency of the output voltage VThermal of FIG. 4.

FIG. 6 is a circuit diagram of a temperature independent reference generating circuit according to an embodiment of the invention.

FIG. 7 is a graph illustrating a temperature dependency of the output voltage Vref of FIG. 6.

FIG. 8 is a circuit diagram of a reference voltage generating circuit according to an embodiment of the invention.

FIG. 9 is a circuit diagram of a reference voltage generating circuit according to an embodiment of the invention.

FIG. 10 is a circuit diagram of a reference voltage generating circuit according to another embodiment of the invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

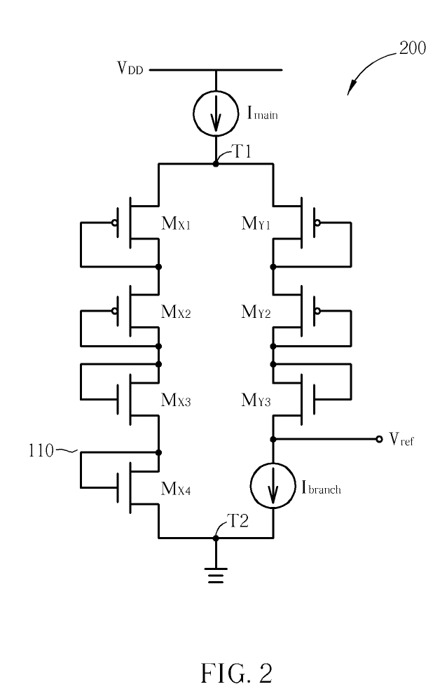

FIG. 2 is a circuit diagram of a reference voltage generating circuit according to an embodiment of the invention. The reference voltage generating circuit 200 includes, but is not limited to, a main current source Imain, a branch current source Ibranch and a plurality of transistors. The plurality of transistors includes transistor MX1, MX2, MX3, MX4, MY1, MY2 and MY3. The transistors MX1, MX2, MY1 and MY2 are PMOS transistors, whereas transistors MX3, MX4, and MY3 are NMOS transistors. Resistive elements are not required; therefore, the circuit 200 can easily be implemented using CMOS technology. It should be noted that the amount, types and arrangement of the plurality of transistors shown in FIG. 2 are simply for illustrative purposes, and one of ordinary skill in the art can readily devise alternative designs based on the teachings of the present invention.

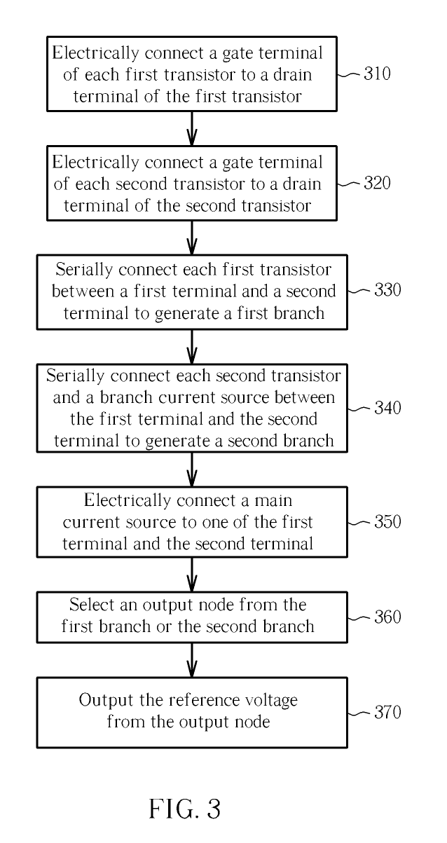

FIG. 3 is a flowchart showing a method for generating a reference voltage according to an embodiment of the invention. The steps for the method of FIG. 3 are as below:

Step 310: Electrically connect a gate terminal of each first transistor to a drain terminal of the first transistor.

Step 320: Electrically connect a gate terminal of each second transistor to a drain terminal of the second transistor.

Step 330: Serially connect each first transistor between a first terminal and a second terminal to generate a first branch.

Step 340: Serially connect each second transistor and a branch current source between the first terminal and the second terminal to generate a second branch.

Step 350: Electrically connect a main current source to one of the first terminal and the second terminal.

Step 360: Select an output node from the first branch or the second branch.

Step 370: Output the reference voltage from the output node.

The steps listed above may be performed in any order, and any of the included steps may be integrated, separated, or omitted so as to obtain substantially the same result and goal of the method. Any such manipulation of the steps above should be considered within the scope of the invention.

According to Step 310, a control terminal of transistors MX1, MX2, MX3 and MX4 is coupled to a first terminal of the transistors. In Step 320, a control terminal of transistors MY1, MY2 and MY3 is coupled to a first terminal of the transistors. In this embodiment, the control terminal is a gate terminal and the first terminal is a drain terminal.

According to Step 330, transistors MX1, MX2, MX3 and MX4 are serially connected between a 1^{st} terminal T1 and a 2^{nd} terminal T2 to form a first branch. As shown in FIG. 2, a drain terminal of transistor MX1 is coupled to a source terminal of transistor MX2; a drain terminal of transistor MX2 is coupled to a drain terminal of transistor MX3, for example. Then, in Step 340, transistors MY1, MY2 and MY3 and the branch current source Ibranch are serially connected between the 1^{st} terminal T1 and the 2^{nd} terminal T2 to form a second branch. As is shown in FIG. 2, a drain terminal of transistor MY1 is coupled to a source terminal of transistor MY2; a drain terminal of transistor MY2 is coupled to a drain terminal of transistor MY3, for example. In this embodiment, the branch current source Ibranch is coupled between the transistor MY3 and the 2^{nd} terminal, but the branch current source Ibranch can be deposited at any position of the second branch.

According to Step 350, the main current source Imain is electrically connected to the 1^{st} terminal T1. In other embodiments, the main current source Imain can be connected to the 2^{nd} terminal T2 instead. Please note that, in this embodiment, flow directions of both the branch current source Ibranch and the main current source Imain are from the Vdd to the ground. In other embodiments, however, the flow direction of either of the branch current source Ibranch and the main current source Imain can be reversed, depending upon design requirements.

Proceeding to Step 360, an output node between the transistor MY3 and the branch current source Ibranch, is selected for supplying the generated reference voltage. According to Step 370, the generated reference voltage Vref is outputted from the selected output node. It should be noted that the output node could be selected from any nodes of the first branch and the second branch. In other words, the circuit architecture shown in FIG. 2 merely serves as one possible implementation of the present invention.

According to Kirchhoff's Voltage Law (KVL), the reference voltage Vref is given by the following equation:

$$Vref = {\sum }_{a = 1}^{4} {Vgs}_{Xa} - {\sum }_{b = 1}^{3} {Vgs}_{Yb} \qquad ( 1 )$$

In the equation (1), the parameters Vgs_{X1}, Vgs_{X2}, Vgs_{X3} and Vgs_{X4} represent gate-source voltages of transistors MX1, MX2, MX3 and MX4, respectively. The parameters Vgs_{Y1}, Vgs_{Y2} and Vgs_{Y3} represent gate-source voltages of transistors MY1, MY2 and MY3, respectively. According to the equation (1), a wide voltage range of Vref can be easily obtained by adjusting the number of transistors in the first branch and the second branch. Compared to the prior art, the reference voltage is no longer limited to 1.25 V.

Moreover, for controlling the temperature dependency of the reference voltage Vref, the MOS transistors could be operated either in the subthreshold region (i.e., Vgs<<Vthor Vgs≅Vth) or in the saturation region (i.e., Vgs>Vth). Assuming the channel length is sufficiently long, V_{BS}=0, and V_{DS}>4V_{T}, the Vgs voltage of a subthreshold MOS has been shown to be a linear function of the temperature was first introduced by Eric Vittoz et al (“CMOS Analog Integrated Circuits Based on Weak Inversion Operation”, IEEE Journal of Solid State Circuits, vol. SC-12, No. 3, June 1977) and then described in a publication by G. Giustolisi et al (“A Low-Voltage Low-Power Voltage Reference Based on Subthreshold MOSFETs”, IEEE Journal of Solid State Circuits, vol. 38, No., January 2003). And the temperature property of Vgs voltage could be expressed as the following equation:

Vgs(T)=Vgs(To)+β(T−To) (2)

In above equation (2), T represents an instant temperature, To represents a reference temperature (e.g., the absolute temperature), Vgs(Tₒ) represents a constant, and β represents a thermal coefficient of gate-source voltage and is process dependent.

For a MOS transistor operated in saturation region, with careful design tradeoffs, i.e., choosing a long channel device and a low biasing current, the channel-length modulation, high-filed mobility degradation, and other higher order effects on the gate-source voltage could be further minimized. Since, it is also well understood that the threshold voltage of a MOS transistor exhibits an almost straight-line decrease with temperature as given in Chapter 4 of Operation and Modeling of The MOS Transistor, 2^{rd} Edition by Yannis Tsividis. Therefore, under prescribed design considerations, the thermal properties of gate-source voltage could be approximated by that of the threshold voltage with good accuracy. This simple observation is confirmed by experimental data and also by a publication by Leung et al (“A CMOS Voltage Reference Based on Waighted ΔVgs for CMOS Low-Dropout Linear Regulators”, IEEE Journal of Solid State Circuits, vol. 38, No. 1, January 2003). As a result, equation (2) also applies to the gate-source voltage of a saturated MOS transistor. Besides, the equivalent thermal coefficient is usually between 0.5 mV/K and 3 mV/K.

To summarize, the temperature dependency of the reference voltage Vref can also be obtained:

$$\begin{matrix}\frac{d Vref}{d T} ≅ \frac{d ( {\sum }_{a = 1}^{4} {Vgs}_{Xa} - {\sum }_{b = 1}^{3} {Vgs}_{Yb} )}{d T} \\ = {\sum }_{a = 1}^{4} {β}_{Xa} - {\sum }_{b = 1}^{3} {β}_{Yb} = β ref\end{matrix} \qquad ( 3 )$$

In equation (3), the parameters β_{X1}, β_{X2}, β_{X3} and β_{X4} represent thermal coefficients of the gate-source voltage of transistors MX1, MX2, MX3 and MX4, respectively. The parameters β_{Y1}, β_{Y2} and β_{Y3} represent thermal coefficients of threshold voltage of transistors MY1, MY2 and MY3, respectively. And the parameter βref represents a thermal coefficient of reference voltage Vref.

According to above equation (3), the thermal coefficient βref of reference voltage Vref is obtained from a difference between a first summation of the thermal coefficient of each transistor electrically connected between the 1^{st} terminal T1 and the 2^{nd} terminal T2 and a second summation of the thermal coefficient of each transistor electrically connected between the 1^{st} terminal T1 and the output node of the circuit 200. While βref is a fixed value, the temperature dependency of the voltage reference Vref can easily be determined. For example, a βref equal to zero represents the reference voltage Vref being independent of temperature, whereas a βref equal to a positive value (or a negative value) represents that the reference voltage Vref indicates the instant temperature. The thermal coefficient βref of reference voltage Vref can be adjusted in many ways. People skilled in the art can obtain a fixed βref by operating the transistors under particular modes, adjusting the width-length ratio of the transistors, adjusting the main current source Imain, adjusting the branch current source Ibranch, or selecting an appropriate output node from the first branch and the second branch. As illustrated above, a temperature independent reference voltage generating circuit or a thermal indicator can be easily obtained.

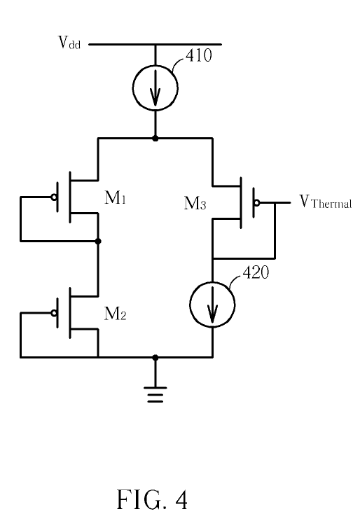

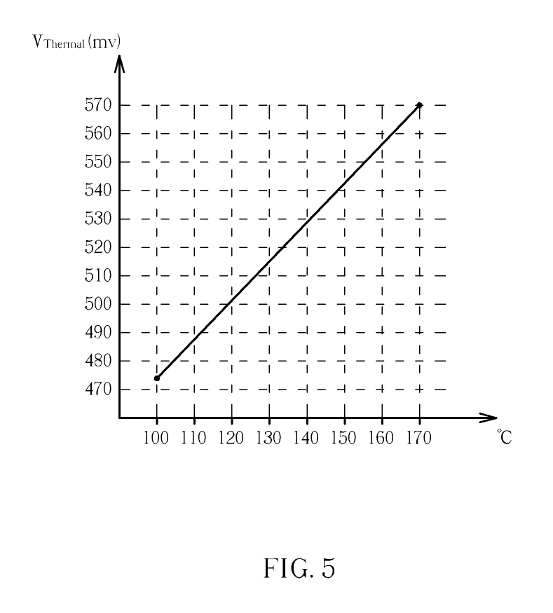

FIG. 4 is circuit diagram of a thermal indicator according to an embodiment of the invention. The thermal indicator 400 comprises a main current source 410 biased at 68 nA, a branch current source 420 biased at 14 nA, and three PMOS transistors M1, M2 and M3. The channel widths of the transistors M1, M2 and M3 are 3 um, 2 um and 9 um, respectively. The channel lengths of the transistors M1, M2 and M3 are 20 um. The output voltage VThermal of the thermal indicator 400 is obtained at a gate terminal of the transistor M3. FIG. 5 is a plot illustrating a temperature dependency of the output voltage VThermal of FIG. 4. In FIG. 5, the output voltage VThermal is a linear function of the temperature, and has a thermal coefficient approximated to +1.33 V/° C.

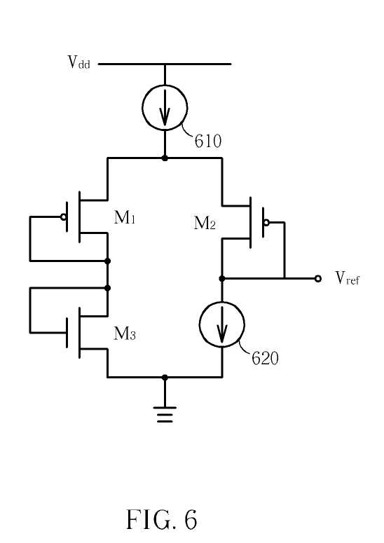

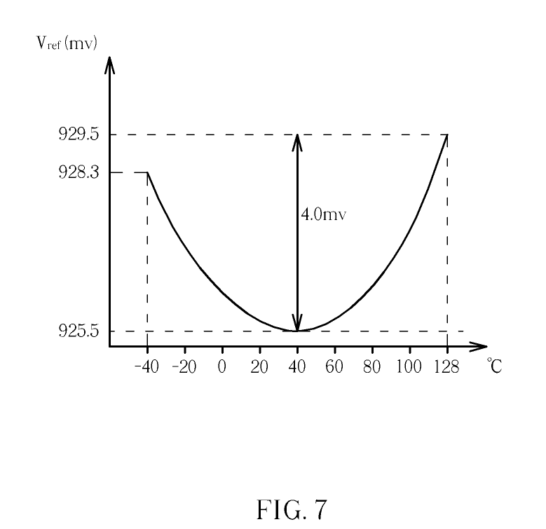

FIG. 6 is a circuit diagram of a temperature independent reference generating circuit according to an embodiment of the invention. The temperature independent reference generating circuit 400 comprises a main current source 610 biased at 200 nA, a branch current source 620 biased at 75 nA, and two PMOS transistors M1 and M2 and a NMOS transistor M3. The channel widths of the transistors M1, M2 and M3 are 10 um, 4.3 um and 10 um, respectively. The channel lengths of the transistors M1, M2 and M3 are 10 um, 4 um and 1 um. In addition, the Vdd of FIG. 6 has a value of 2.5V. The output voltage Vref of the temperature independent reference generating circuit 600 is obtained at a gate terminal of the transistor M3. FIG. 7 is a graph illustrating a temperature dependency of the output voltage Vref of FIG. 6. In FIG. 7, when the temperature varies from −40° C. to 128° C., the variation of the reference voltage Vref is about 4 mV. The thermal coefficient of the reference voltage Vref therefore approximates to 0.

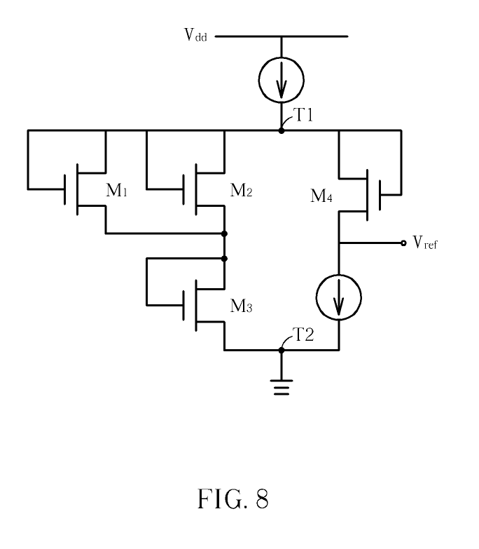

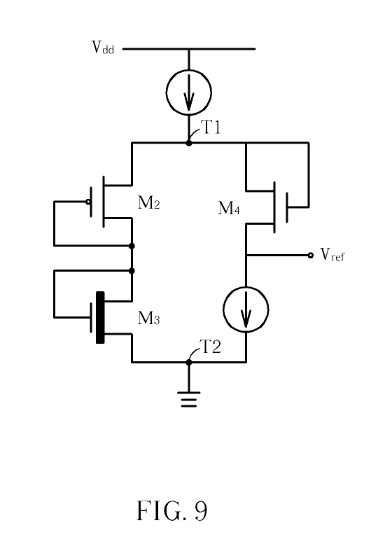

FIG. 8 is a circuit diagram of a reference voltage generating circuit according to an embodiment of the invention. It should be noted that transistors coupled between the 1^{st} terminal T1 and 2^{nd} terminal T2 can coupled in parallel (e.g., transistors M1 and M2), since the parallel-connected transistors M1 and M2 are equivalent to one transistor. In addition, all NMOS transistors (or all PMOS transistors) can be utilized in the reference voltage generating circuit. FIG. 9 is a circuit diagram of a reference voltage generating circuit according to an embodiment of the invention. It should be noted that a PMOS transistor M1, a depletion transistor M2 and an NMOS transistor M3 can be mixed between the 1^{st} terminal T1 and the 2^{nd} terminal T2. Since thermal coefficients of threshold voltage of different types of transistors are different, it is more flexible to devise a thermal coefficient of the reference voltage Vref. As the operation of the circuits in FIG. 8 and FIG. 9 are similar to the operation of the circuit in FIG. 2, further description is omitted for brevity.

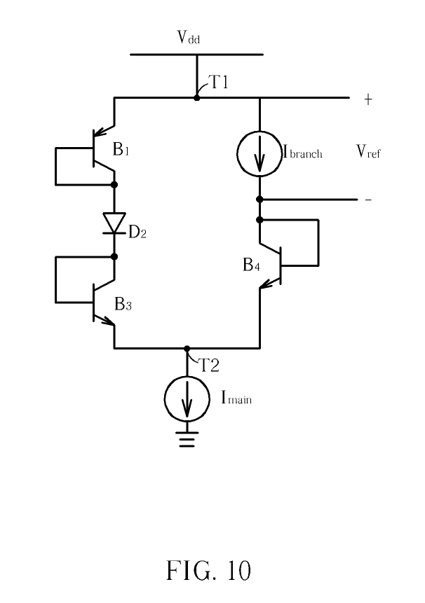

FIG. 10 is a circuit diagram of a reference voltage generating circuit according to another embodiment of the invention. As shown in FIG. 10, it should be noted that the MOS transistors in above-mentioned embodiments can be replaced with other semiconductor devices, e.g. a BJT transistor or a diode. If replacing with a BJT transistor, e.g. replacing with N-type BJT or P-type BJT, the replacing BJT transistor still serially connects with other semiconductors the circuits and has a base terminal coupled to a collector terminal of the BJT transistor. If replacing with a diode, e.g. replacing with P-N junction diode, Zener diode, or Shotty diode, the replacing diode still serially connects with other semiconductors, and Steps 310 and 320 in FIG. 3 can be omitted since diodes only have two terminals. After replacing MOS transistors with other semiconductors, people skill in the art can readily adjust the bias or the size of the semiconductors to obtain a reference voltage Vref having a fixed thermal coefficient under the teaching of the above-mentioned embodiments, therefore, detailed description is omitted for brevity. In FIG. 10, please noted that, the outputting reference voltage Vref can reference to the Vdd or to any other fixed voltages.

To conclude, under the teachings of the apparatus and method of the above-mentioned embodiments, users can obtain a reference voltage having adjustable temperature dependency and having a wide output range by flexibly adjusting the bias current or the size of the transistors. In addition, resistive elements are not required. Therefore, the reference voltage can be easily implemented using CMOS technology. It will also be understood that the present invention has been described with reference to specific configurations of CMOS transistors and that is not intended that the application of the invention be limited to such configurations. As will be understood by the person skilled in the art many modifications and verifications in configurations may be achieved by implementation with P-N junction diode, Zener diode, or even VBE-multiplier circuit or the like. Those skilled in the art will readily observe that numerous modifications also in GaAs, Bipolar, and TFT technologies, etc. and alterations of the device and method may be made while retaining the teachings of the invention.

What is claimed is:

1. A circuit for generating a reference voltage at an output node, comprising:
a first branch, electrically connected between a first terminal and a second terminal of the circuit, the first branch comprising at least one first semiconductor device, wherein each first semiconductor device at least comprises a first node and a second node;
a second branch, electrically connected between the first terminal and the second terminal of the circuit, comprising:
at least one second semiconductor device, wherein each second semiconductor device comprises a first node and a second node; and
a branch current source, serially connected to the second semiconductor device; and
a main current source, electrically connected to one of the first terminal and the second terminal of the circuit;
wherein the output node is in the first branch or the second branch.

2. The circuit of claim 1, wherein the first semiconductor device further comprises a control node electrically connected to the first node of the first semiconductor device, and the second semiconductor device further comprises a control node electrically connected to the first node of the second semiconductor device.

3. The circuit of claim 2, wherein each first semiconductor device is a MOS transistor, and each second semiconductor device is a MOS transistor.

4. The circuit of claim 3, wherein the control node of the first semiconductor device is a gate terminal, the first node of the first semiconductor device is a drain terminal, the control node of the second semiconductor device is a gate terminal, and the first node of the second semiconductor device is a drain terminal.

5. The circuit of claim 3, wherein each first semiconductor device is operated under a subthreshold region or a saturation region, and each second semiconductor device is operated under a subthreshold region or a saturation region.

6. The circuit of claim 3, wherein each first semiconductor device is individually selected from a group consisting of an NMOS transistor, a PMOS transistor and a depletion MOS transistor; and each second semiconductor device is individually selected from a group consisting of an NMOS transistor, a PMOS transistor and a depletion MOS transistor.

7. The circuit of claim 1, wherein the output node is in the second branch.

8. The circuit of claim 7, wherein each first semiconductor device of the first branch is serially connected between the first terminal and the second terminal of the circuit, and each second semiconductor device of the second branch is serially connected between the first terminal and the second terminal of the circuit.

9. The circuit of claim 8, wherein a difference between a first summation of a thermal coefficient of threshold voltage or cut-in voltage of each first semiconductor device electrically connected between the first terminal and the second terminal of the circuit and a second summation of a thermal coefficient of threshold voltage or cut-in voltage of each second semiconductor device electrically connected between the first terminal and the output node of the circuit is a fixed value.

10. The circuit of claim 2, wherein each first semiconductor device is a BJT transistor, and each second semiconductor device is a BJT transistor.

11. The circuit of claim 10, wherein the control node of the first semiconductor device is a base terminal, the first node of the first semiconductor device is a collector terminal, the control node of the second semiconductor device is a base terminal, and the first node of the second semiconductor device is a collector terminal.

12. The circuit of claim 1, wherein each first semiconductor device is individually selected from a group consisting of a P-N junction diode, a Zener diode, and a Schotty diode; and each second semiconductor device is individually selected from a group consisting of a P-N junction diode, a Zener diode, and a Schotty diode.

13. A method for generating a reference voltage, comprising:
serially connecting each first semiconductor device between a first terminal and a second terminal to generate a first branch;
serially connecting each second semiconductor device and a branch current source between the first terminal and the second terminal to generate a second branch;
electrically connecting a main current source to one of the first terminal and the second terminal;
selecting an output node from the first branch or the second branch; and
outputting the reference voltage from the output node.

14. The method of claim 13, further comprising:
electrically connecting a control node of the first semiconductor device to the first node of a first semiconductor device; and
electrically connecting a control node of the second semiconductor device to a first node of the second semiconductor device.

15. The method of claim 14, wherein each first transistor is a MOS transistor, and each second transistor is a MOS transistor.

16. The circuit of claim 15, wherein the control node of the first semiconductor device is a gate terminal, the first node of the first semiconductor device is a drain terminal, the control node of the second semiconductor device is a gate terminal, and the first node of the second semiconductor device is a drain terminal.

17. The circuit of claim 15, wherein each first semiconductor device is individually selected from a group consisting of an NMOS transistor, a PMOS transistor and a depletion MOS transistor; and each second semiconductor device is individually selected from a group consisting of an NMOS transistor, a PMOS transistor and a depletion MOS transistor.

18. The method of claim 15, further comprising:
adjusting a width-length ratio of at least one first transistor or a width-length ratio of at least one second transistor to make a thermal coefficient of the reference voltage be a fixed value.

19. The method of claim 15, further comprising:
operating each first semiconductor device and each second semiconductor device under a subthreshold region or a saturation region to make a thermal coefficient of the reference voltage be a fixed value.

20. The method of claim 13, further comprising:
adjusting the main current source or the branch current source to make a thermal coefficient of the reference voltage be a fixed value.

21. The method of claim 13, further comprising:
selecting the output node from the second branch.

22. The method of claim 21, further comprising:
selecting the output node from the second branch to make a thermal coefficient of the reference voltage be a fixed value.

23. The method of claim 14, wherein each first semiconductor device is a BJT transistor, and each second semiconductor device is a BJT transistor.

24. The method of claim 23, wherein the control node of the first semiconductor device is a base terminal, the first node of the first semiconductor device is a collector terminal, the control node of the second semiconductor device is a base terminal, and the first node of the second semiconductor device is a collector terminal.

25. The method of claim 13, wherein each first semiconductor device is individually selected from a group consisting of a P-N junction diode, a Zener diode, and a Schotty diode; and each second semiconductor device is individually selected from a group consisting of a P-N junction diode, a Zener diode, and a Schotty diode.
